(19) United States
(12) Patent Application Publication
(10) Pub. No.: US 2023/0034244 A1
(43) Pub. Date: Feb. 2, 2023

(54) SECURE MARKING METHOD AND DEVICE AND AUTHENTICATION METHOD AND DEVICE

(71) Applicant: ADVANCED TRACK & TRACE, Rueil-Malmaison (FR)

(72) Inventors: Jean-Pierre MASSICOT, Rueil-Malmaison (FR); Zbigniew SAGAN, Rueil-Malmaison (FR)

(21) Appl. No.: 17/756,417

(22) PCT Filed: Nov. 27, 2020
(86) PCT No.: PCT/EP2020/083810

§ 371 Date: May 25, 2022

(30) Foreign Application Priority Data
Nov. 28, 2019 (FR) FR1913380
Dec. 30, 2019 (FR) FR1915744

(51) Int. Cl. G06K 19/06

(52) U.S. Cl. CPC G06K 19/06056; G06K 19/0614; G06K 19/06037; G06K 2019/06225; G06K 19/06075

(57) ABSTRACT

A method for securely marking an object, comprising:
a step of determining a maximum cell size (302) of a two-dimensional barcode (301), the cell size being defined by an area containing a number of dots (304, 305),
a step of estimating a minimum number of dots of a predetermined colour referred to as the “main colour” in a cell such that the cell is detected as being said colour by a predetermined reader,
   a step of encoding a message in cells of a two-dimensional barcode by defining the main colour of each cell, said message representing at least one instance of access to a remote resource,
   for at least one cell, a step of defining an image (306) to be represented in the cell, the number of dots in the colour image defining the cell being greater than the estimated minimum number and
   a step of marking the object with the secure two-dimensional barcode.

### TECHNICAL FIELD OF THE INVENTION

This invention relates to a secure marking method and device, and an authentication method and device. It applies, among others, to the field of securing documents and verifying the integrity of documents.

### STATE OF THE ART

Currently, the information storage capacity of 2D (two-dimensional) barcodes mainly depends on the dimensions of the cells forming the code and the dimensions of the code. However, some portions of the message do not need to be incorporated in the code since they can be reconstituted or retrieved after the available data is acquired.

US patent application US 2017/076191, French patent application FR 3 054 699, and the scientific publication by Duncan Robertson et al., “Whomwah.com”, “More fun with QR Codes and the BBC logo” that discloses methods for obtaining 2D barcodes including symbols in the cells, are known.

### DESCRIPTION OF THE INVENTION

The present invention aims to remedy all or part of these drawbacks.

To this end, according to a first aspect, the present invention envisages a method for securely marking an object, which method comprises:
a step of determining a maximum size for each cell of a 2D barcode defined according to at least two predetermined colors, the maximum size of each cell being defined by an area containing a number of dots;
a step of estimating a minimum number of dots of one color among the two colors defining said 2D barcode, referred to as the “main color”, in a cell of the 2D barcode such that the cell is detected as being said color by a predetermined reader;
a step of encoding a message in at least one portion of cells of the 2D barcode by defining the main color, said message representing at least one instance of access to a remote resource;
for at least one cell of the 2D barcode, a step of incorporating an image in said cell, the number of dots in the color image defining the cell being greater than or equal to the estimated minimum number; and
a step of marking the object with the secure 2D barcode.

Thanks to these provisions, the sizes of the 2D barcode can be reduced because some information can be made visible or accessible to an automated reading process without affecting the 2D barcode's readability.

In some embodiments, the remote resource generates at least one question about the image represented by at least one cell of the barcode marked.

Thanks to these provisions, the user can carry out a first verification of the 2D barcode's authenticity. The information provided by the user can also be used for an authenticity verification calculation on the remote resource.

In some embodiments, at least one cell of the 2D barcode is a fragile anti-copy mark.

The advantage of these embodiments is to make copying very difficult for a third party; in addition, the images will be significantly deteriorated if a copy is made.

In some embodiments, during the encoding step, the message is encoded with redundancies and/or an error correction code.

These embodiments make it possible to maintain access to the remote resource even if the 2D barcode is degraded or incomplete.

In some embodiments, the image is representative of an alphanumeric character.

Thanks to these provisions, it is easy for a user to respond to questions by means of a digital keyboard, for example.

In some embodiments, the image is selected randomly or pseudo-randomly from a library of images.

These embodiments allow the security of the code to be increased.

In some embodiments, the secure marking method that is the subject of the present invention also comprises a step of orienting the image in the area defining the cell.

The advantage of these embodiments is that one question can relate to the orientation of the image in the area defining the cell.

In some embodiments, the image is represented by a color with a luminance greater than the luminance of the main color.

These embodiments make it possible to improve the reading of the code while enabling an item of information to be incorporated into the image represented by the cell.

According to a second aspect, the present invention envisages a device for securely marking an object, which device comprises:
a means for determining a maximum size for each cell of a 2D barcode defined according to at least two predetermined colors, the maximum size of each cell being defined by an area containing a number of dots;
a means for estimating a minimum number of dots of a predetermined color, among the two colors defining said 2D barcode, referred to as the “main color”, in a cell of the barcode such that the cell is detected as being said color by a predetermined reader;
a means for encoding a message in at least one portion of cells of the 2D barcode by defining the main color, this message representing at least one instance of access to a remote resource;
a means for incorporating, for at least one cell of the 2D barcode, an image in said cell, the number of dots in the color image defining the cell being greater than or equal to the estimated minimum number; and
a means for marking the object with the secure 2D barcode.

As the particular aims, advantages and features of the secure marking device that is the subject of the present invention are similar to those of the secure marking method that is the subject of the present invention, they are not repeated here.

According to a third aspect, the present invention envisages a method for authenticating an object, which method comprises:
a step of reading, by means of the predetermined reader, a secure 2D barcode, representative of at least one access to a remote resource, obtained by a secure marking method that is the subject of the present invention;
by means of a terminal accessing the remote resource:
   a step of displaying a question relating to the image represented in at least one cell;
   a step of entering a response to the question displayed;
   a step of comparing the response entered with a response contained in a database and/or the message; and
   if the responses do not match, a step of broadcasting an alert message to the user.

Thanks to these provisions, the user can verify the authenticity of the code and/or can supply information to a remote resource for verifying the authenticity of the code.

According to a fourth aspect, the present invention envisages a device for authenticating an object, which device comprises:
the predetermined reader of a secure 2D barcode, representative of at least one access to a remote resource, obtained by a secure marking method that is the subject of the present invention;
a terminal accessing the remote resource, said terminal comprising:
   a means for displaying a question relating to the image represented in at least one cell;
   a means for entering a response to the question displayed;
   a means for comparing the response entered with a response contained in a database and/or the message; and
   a means for broadcasting an alert message to the user if the responses do not match.

As the particular aims, advantages and features of the authentication device that is the subject of the present invention are similar to those of the authentication method that is the subject of the present invention, they are not repeated here.

The different aspects and particular characteristics of the present invention are intended to be combined with each other such that a marking of an object according to one of the first two aspects enables this object to be authenticated according to one of the last two aspects.

### BRIEF DESCRIPTION OF THE FIGURES

Other advantages, aims and particular features of the invention will become apparent from the non-limiting description that follows of at least one particular embodiment of the secure marking method and device and the authentication method and device that are the subjects of the present invention, with reference to drawings included in an appendix, wherein:

FIG. 1 represents schematically, in the form of a logic diagram, a particular series of steps of the secure marking method that is the subject of the present invention;

FIG. 2 represents, schematically, a first particular embodiment of a secure marking device that is the subject of the present invention;

FIG. 3 represents, schematically, a first embodiment of a secure marking obtained by a method that is the subject of the present invention;

FIG. 4 represents schematically, in the form of a logic diagram, a particular series of steps of the authentication method that is the subject of the present invention;

FIG. 5 represents, schematically, a first particular embodiment of an authentication device that is the subject of the present invention;

FIG. 6 shows, schematically, a second embodiment of a secure marking obtained by a method that is the subject of the present invention;

FIG. 7 represents, schematically, a third embodiment of a secure marking obtained by a method that is the subject of the present invention;

FIG. 8 represents, schematically, a fourth embodiment of a secure marking obtained by a method that is the subject of the present invention; and

FIG. 9 represents, schematically, a fifth embodiment of a secure marking obtained by a method that is the subject of the present invention.

### DESCRIPTION OF EMBODIMENTS

The present description is given in a non-limiting way, in which each characteristic of an embodiment can be combined with any other characteristic of any other embodiment in an advantageous way.

Note that the figures are not to scale.

The terms below have the following meanings:
Object: Anything that is tangible and perceptible to the eye and touch, for example an electronic chip or document on which an item of information is marked.
Dot: the smallest element for marking an object, for example a dot on a physical object commensurate with a pixel.
Cell: a set of dots defined by at least two dimensions as a number of dots; the shape of a cell can be any known shape, e.g. a square, a rectangle, or even a circle.
2D barcode: a two-dimensional graphical code comprising cells, for example squares, each cell being at least one color among two distinct colors; examples of 2D barcodes are QR codes (registered trademark, acronym for “Quick Response”), DataMatrix codes and Semacodes (registered trademark).
Marking: the affixing of a digital graphical element on an object, for example by engraving or printing.
Fragile anti-copy mark: a mark whose degradation by noise (i.e. the generation of individually unpredictable sporadic errors, resulting in a dot being interpreted with an incorrect value) during marking, then copying, can be measured to distinguish an original from a copy.

In the rest of the description, the cells and the 2D barcodes are square in shape for the purposes of illustration. The person skilled in the art could use cells and 2D barcodes of different shapes.

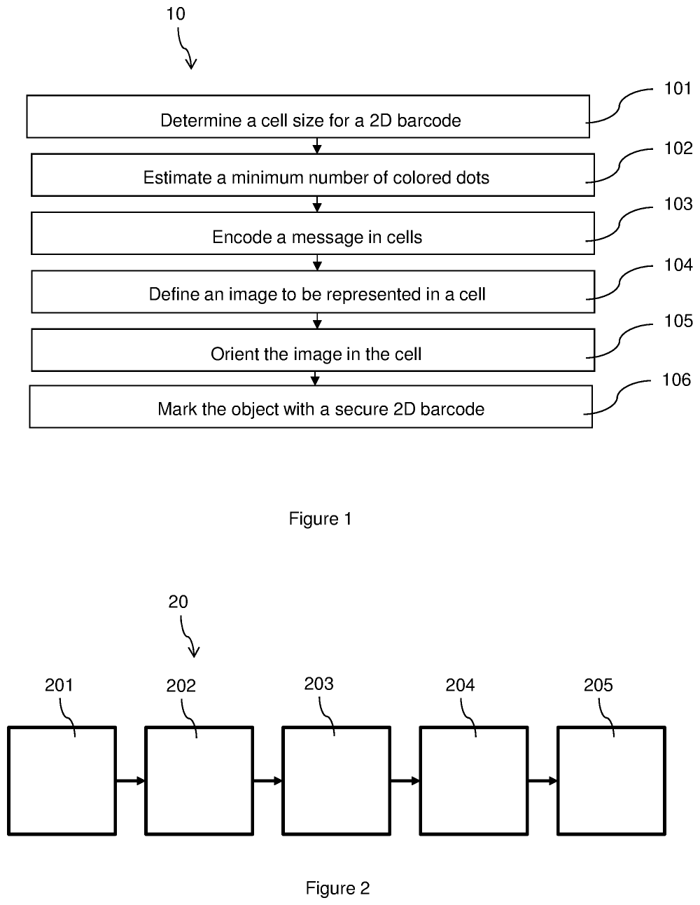

FIG. 1 shows, in the form of a logic diagram, a first embodiment of a method 10 for securely marking an object, said method being the subject of the present invention.

The method 10 for securely marking an object comprises:
a step 101 of determining a maximum size for each cell of a 2D barcode defined according to at least two predetermined colors, the maximum size of each cell being defined by an area containing a number of dots;
a step 102 of estimating a minimum number of dots of one color, among the two colors defining said 2D barcode, referred to as the “main color”, in a cell of the 2D barcode such that the cell is detected as being said color by a predetermined reader;
a step 103 of encoding a message in at least one portion of cells of the 2D barcode by defining the main color, this message representing at least one instance of access to a remote resource;
for at least one cell of the 2D barcode, a step 104 of incorporating an image in said cell, the number of dots in the color image defining the cell being greater than or equal to the estimated minimum number; and
a step 106 of marking the object with the secure 2D barcode.

The maximum and minimum sizes of a 2D barcode depend on:
the area allocated on the object for placing the 2D barcode, defining a maximum size of the 2D barcode; and
the amount of information to be encoded in the 2D barcode, influencing the minimum size of the 2D barcode.

The area allocated on the object is chosen by the operator affixing the 2D barcode on the object. This operator is the producer of the object or its distributor, for example.

The number of colors in the 2D barcode can influence the amount of information that can be encoded in a 2D barcode.

To be able to be read by a predetermined reader, the 2D barcodes must have cells whose minimum sizes are specified in the various technical specifications and standards defining these codes.

Consequently, based on the area allocated on the object and the amount of information to be encoded, minimum sizes for cells, and therefore the minimum and maximum sizes of a 2D barcode, can be determined.

In other words, the maximum size of the cells can be determined based on the sizes of the 2D barcode (which depends on the area allocated) and the amount of information to be encoded.

In addition, depending on the marking resolution, sizes expressed in centimeters or millimeters, for example, are expressed as a number of dots, for example in dots per inch (“DPI”).

During the determination step 101, the maximum size of cells is calculated as a function of at least the marking resolution, the area allocated on the object, and the amount of information to be encoded.

Once the number of cells has been determined, the minimum number of dots of a predetermined color in a cell, such that the cell is detected as being said color by a predetermined reader, is estimated 102.

The predetermined color is one of the colors used in a 2D barcode. Generally, the 2D barcodes have two colors, preferably black and white. In some embodiments, the 2D barcodes have three or more colors.

For the rest of the description, the general case of two colors, black and white, is chosen to illustrate the invention. The following description can, of course, be adapted to the case of at least three colors or colors other than those mentioned.

As a minimum, for a color to be detected correctly by the reader, the cell must strictly comprise more than 50% of dots of said color. For example, for a cell with a size of 10 dots by 10 dots, at least 51 dots must be black for the cell to be detected as black.

However, it is known to the person skilled in the art that the marking step and the reading step cause random errors whose rate can be determined and predicted.

During the estimation step 102, the error rate in marking and reading, by the predetermined reader, is calculated, measured, or estimated. And the minimum number of dots of a predetermined color is estimated to predict said error rate obtained.

The encoding step 103 can be performed by means known to the person skilled in the art, for example by means of a symmetric key or an asymmetric key, in a way well known to the person skilled in the art.

During the encoding step 103, the color of a cell, such as it must be detected by the predetermined reader, is defined. Said color is called the “main color”.

The message represents, for example, a website.

Preferably, at least one cell of the 2D barcode is a fragile anti-copy mark. In these embodiments, during the estimation step 102, the error rate is calculated, measured, or estimated, so as to correspond to an original. And the minimum number of dots of a predetermined color is estimated to predict said error rate obtained.

Preferably, during the encoding step 103, the message is encoded with redundancies and/or an error correction code so that the message is read correctly even if the 2D barcode has errors.

Then, for at least one cell, the method 10 comprises a step 104 of defining an image to be represented in said cell, the number of dots in the color image defining the cell being greater than or equal to the estimated minimum number. During the definition step 104, the image can be selected from a database of images satisfying the constraint concerning the number of dots of the image with the color defining the cell, and the maximum number of colors of the 2D barcode.

Preferably, the image represents an alphanumeric character. For example, the dots of the color whose number is greater than or equal to the estimated minimum number represent an alphanumeric character. For example, in a case that must be read as being black, the black dots represent the alphanumeric character.

Preferably, the image is represented by a color with a luminance greater than the luminance of the main color. In effect, it is common for 2D barcode readers to convert the image read into greyscale. Therefore, the greater luminance of the image increases the ability to read the cell as being the right color, since the greyscale detected for the cell is higher in this case.

In other embodiments, the dots, other than the dots of the color whose number is greater than or equal to the estimated minimum number, represent an alphanumeric character. For example, in a case that must be read as being white, the black dots represent the alphanumeric character.

In some embodiments, only one portion of all the alphanumeric characters can be represented in an image. That is, some characters are considered too close to another character to be represented. Examples of such characters are “O” and “Q”, and “P” and “R”. Just one of these characters can be represented on the same 2D barcode. This information can be noted on the remote resource.

In some embodiments, the alphanumeric character represented can be in upper case or lower case.

Preferably, the characters refer to an element of the message. Therefore, the 2D barcode does not need to be recorded, for verification, only the message needs to be decoded.

In some embodiments, the images are selected randomly or pseudo-randomly from a library of images. In the context of characters, the characters are selected randomly or pseudo-randomly from a portion or all of the known alphanumeric characters.

Preferably, the method 100 comprises a step 105 of orienting the image in the area defining the cell. The image can have dimensions equal to the dimensions of the cell, the image can be oriented, for example by making a quarter- or half-turn relative to an orientation defined as being a main orientation. During the orientation step 105, each cell can have a specific orientation independent of the orientation of surrounding cells relative to the same main orientation.

Preferably, the remote resource generates at least one question about the image represented by at least one cell of the barcode marked. Each question can relate to the orientation of the image and/or its content. The question references the cell about which the question is asked, relative to an element of the 2D barcode. For example, the question can be: “In the QR code, what character can you read in the cell in the corner that has no orientation plot?”

As the characters concerning the question can be stored on a remote resource, there is no limit on the number of characters making up the question.

The secure 2D barcode obtained in this way is then marked 106 on the object. The marking step 106 is carried out by any means known to the person skilled in the art, for example a printer or a laser for engraving the object.

In some embodiments, the 2D barcode generated is recorded.

To summarize, the present code is such that the storage capacity of the 2D barcode can only be increased since a portion of the message, provided it does not need to be secret, can be incorporated in the images of the cells. In addition, verification against the content of the cells enables a first authentication of the code and therefore of the object on which it is affixed.

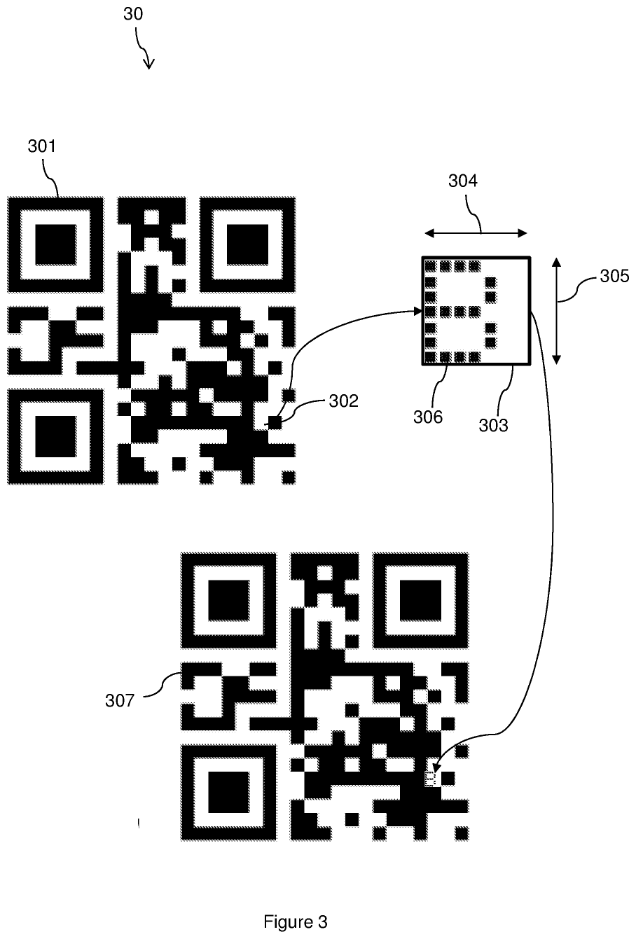

FIG. 2 represents a first particular embodiment of a secure marking device 20 that is the subject of the present invention.

The device 20 for securely marking an object, comprises:
a means 201 for determining a maximum size for each cell of a 2D barcode defined according to at least two predetermined colors, the maximum size of each cell being defined by an area containing a number of dots;
a means 202 for estimating a minimum number of dots of one color, among the two colors defining said 2D barcode, referred to as the “main color”, in a cell of the 2D barcode such that the cell is detected as being said color by a predetermined reader;
a means 203 for encoding a message in at least one portion of cells of the 2D barcode by defining the main color, this message representing at least one instance of access to a remote resource;
a means 204 for incorporating, for at least one cell of the 2D barcode, an image in said cell, the number of dots in the color image defining the cell being greater than or equal to the estimated minimum number; and
a means 205 for marking the object with the secure 2D barcode.

Preferably, the embodiments of the device 20 are configured to utilize the steps of the method 10 and their embodiments as described above, and the method 10 and its different embodiments can be utilized by the embodiments of the device 20.

The means for determination 201, estimation 202, encoding 203 and definition 204 are preferably utilized by a microcontroller utilizing the calculations.

The marking means 205 can be any means known to the person skilled in the art, such as a printer or a laser for engraving the object.

FIG. 3 shows a first embodiment of a 2D barcode obtained by a securitization method that is the subject of the present invention.

FIG. 3 represents a 2D barcode 301 comprising an encoded message. The encoded message is represented by black or white square cells 302. The 2D barcode 301 is a QR code recognizable at three orientation plots of the code in three corners of the code.

FIG. 3 also shows a close-up of a white cell 302 into which an image 306 is incorporated. Image 306 represents an upper-case letter “B” positioned along one side of the cell, here the left side. In FIG. 3, a border 303 defines the cell for greater clarity.

Cell 302 has two dimensions, 304 and 305, along two orthogonal straight lines parallel to the sides of the cell. As cell 302 is a square, the dimensions 304 and 305 are equal. The dimensions 304 and 305 correspond to seven dots.

The area represented by the cell is 49 dots. The letter B represented in the image occupies 20 dots, i.e. approximately forty percent of the area of the cell.

Lastly, FIG. 3 shows a secure 2D barcode 307 in which cell 302 has been replaced by image 306. In other words, image 306 has been incorporated into cell 302.

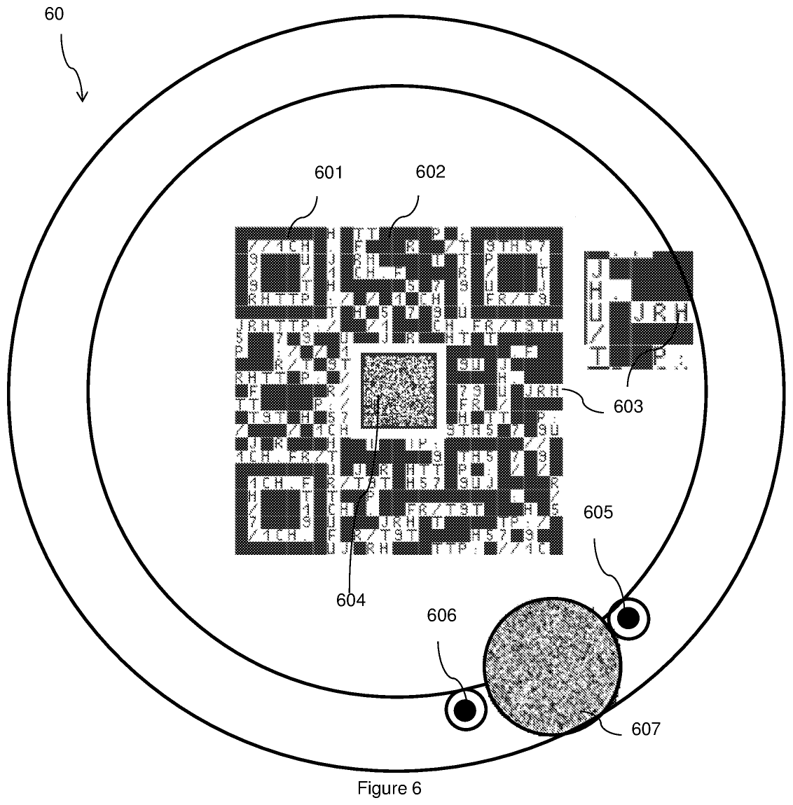

FIG. 6 shows a second particular embodiment of a 2D barcode obtained by a securitization method that is the subject of the present invention.

In FIG. 6, the 2D barcode 60 has the form of a QR code (registered trademark, acronym for “Quick Response Code”). A QR code (registered trademark) has a square shape and comprises at least one orientation element for reading the code, also known as “plot”, and a payload space. One reading orientation element of the code is a black square, containing another black square on a white background in its center. Of course, the colors of the orientation element can be adapted according to the colors utilized for representing the 2D barcode.

In the embodiment shown, the message is encoded in the black cells 602, the white cells serving as a contrast color for detecting and decoding the code.

In the embodiment shown, the QR code comprises three plots 601 positioned at the corners of the square defining the general shape of the QR code. In FIG. 6, the white cells of each plot represent alphanumeric characters. The white cells 603 of the payload space also represent alphanumeric characters.

In FIG. 6, at least four cells in the center of the QR code are replaced by a DataMatrix (registered trademark) code 604. The DataMatrix code 604 is surrounded by white cells, with no image, for facilitating its detection by a reader. In the embodiment shown, the DataMatrix code 604 has a size of six cells by six cells of the QR code.

FIG. 6 shows a SealVector (registered trademark), 605, 606, 607. The SealVector comprises two orientation elements 605 and 606. The orientation elements are black circles surrounded by white on a black background. The SealVector comprises a circular payload space 607. To determine the position of the SealVector and decode it, the center of the orientation elements 605 and 606 is calculated, the position of the SealVector being defined in relation to the position of said centers. Once the position and orientation of the SealVector have been identified, it can be decoded.

Reminder: a SealVector is a specific fragile anti-copy mark.

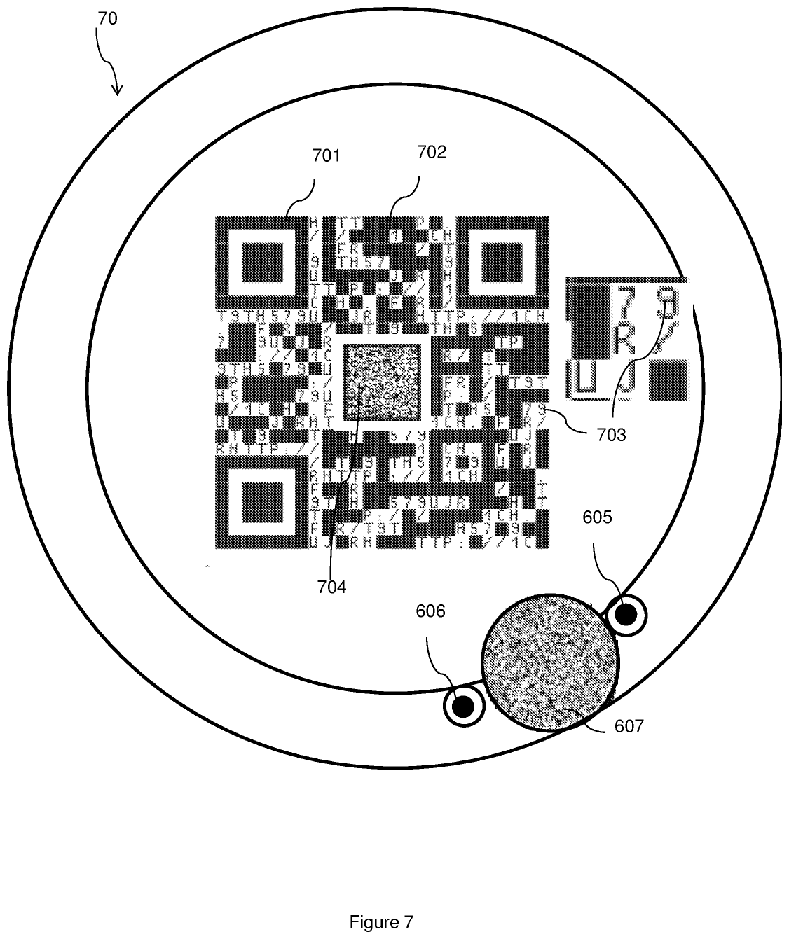

FIG. 7 shows a variant of the embodiment shown in FIG. 6 in which the white cells of the plots of the QR code do not represent an image.

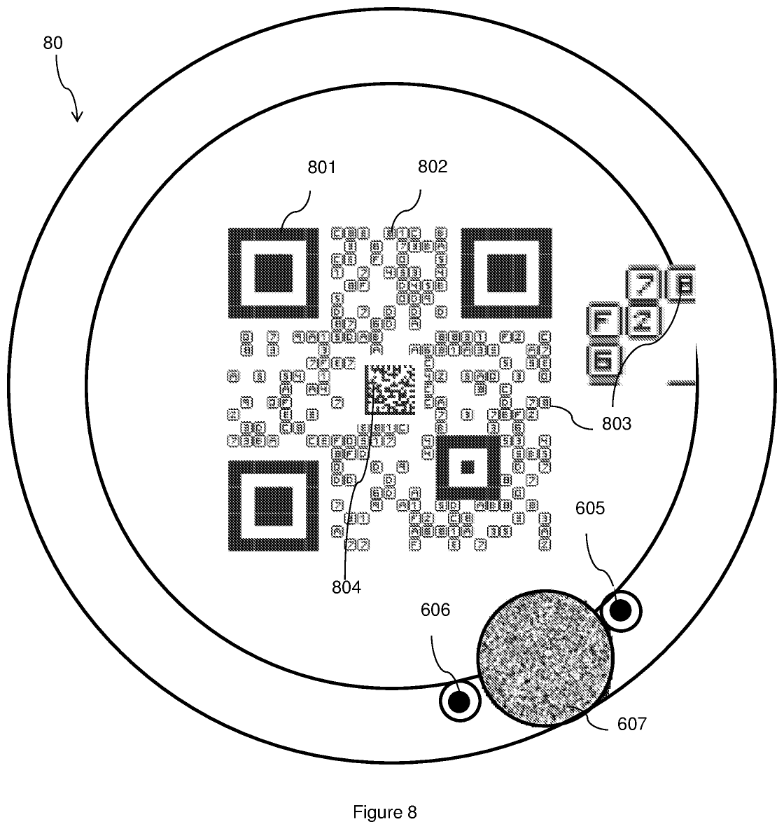

In FIG. 8, the images are carried by the black cells, i.e. the cells encoding the message. The images represent an alphanumeric character surrounded by a black border. In the embodiment shown, the border is a square with rounded edges whose dimensions correspond to the dimensions of a cell with a black main color.

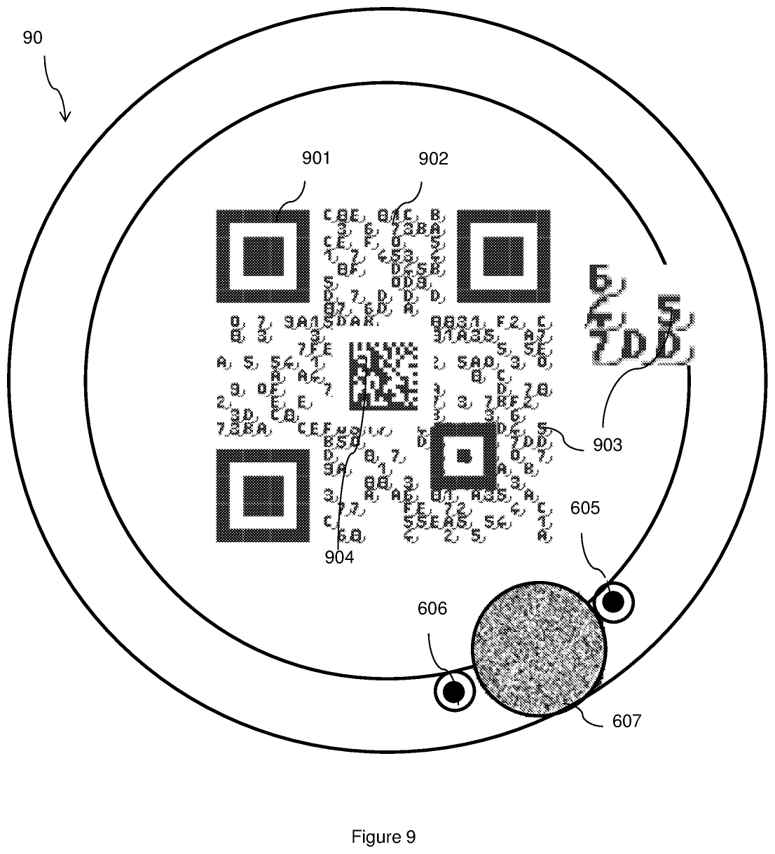

In FIG. 9, the images are carried by the black cells, i.e. the cells encoding the message. The images represent an alphanumeric character accompanied by a comma.

The embodiments shown in FIGS. 3, 6, 7, 8 and 9 facilitate optical character recognition.

In some embodiments, where the dimensions of the marked code are sufficient, at least one cell or each cell can represent a DataMatrix or any other type of 2D barcode.

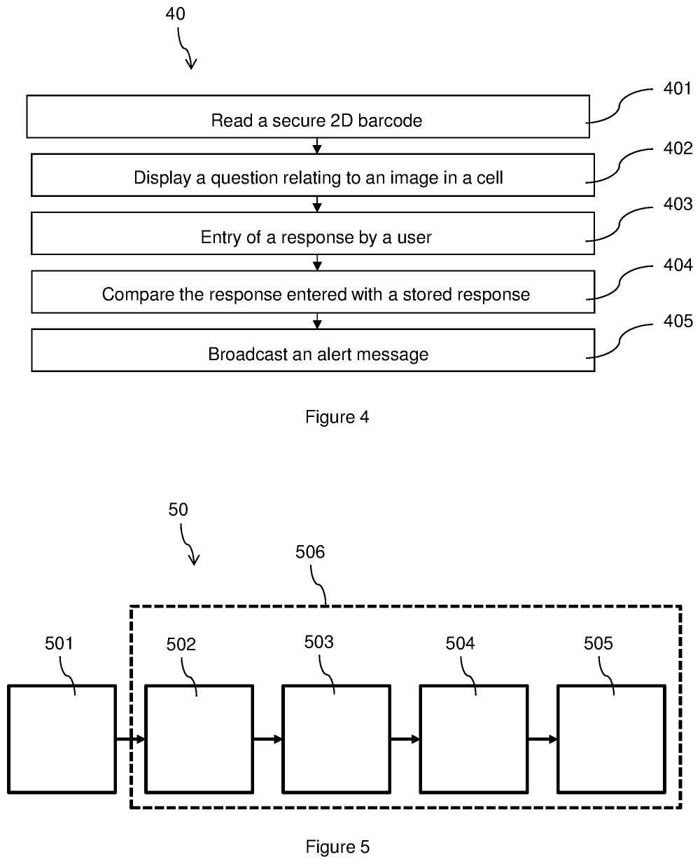

FIG. 4 shows a particular embodiment of a method 40 for authenticating an object, said method being the subject of the present invention.

The method 40 comprises:
a step 401 of reading, by means of the predetermined reader 501, a secure 2D barcode, representative of at least one access to a remote resource, obtained by a method 10;
by means of a terminal 506 accessing the remote resource:
   a step 402 of displaying a question relating to the image represented in at least one cell;
   a step 403 of entering a response to the question displayed;
   a step 404 of comparing the response entered with a response contained in a database and/or the message; and
   if the responses do not match, a step 405 of broadcasting an alert message to the user.

During the reading step 401, at least one portion of the message representative of at least one access to a remote resource is decoded by the reader 501 in a way well known to the person skilled in the art.

A terminal 506 accesses the remote resource. The terminal 506 can be a smartphone, computer, digital tablet, a connected watch or glasses, or any other terminal known to the person skilled in the art.

The terminal 506 and the reader 501 are shown in FIG. 5 in the embodiment of a device 50 for authenticating an object.

The remote resource displays 402, on a screen 502 of the terminal 506, at least one question relating to the image represented in at least one cell. Where several questions are displayed, they can be displayed simultaneously or in succession.

Each question can relate to the orientation of the image or its content. The question references the cell about which the question is asked, relative to an element of the 2D barcode. For example, the question can be: “In the QR code, what character can you read in the cell in the corner that has no orientation plot?”

The questions can be generated randomly during the access to the remote resource, for example.

The user examines the requested cell and enters 403 the response to the question by means of a keyboard 503 of the terminal 506. The entry can also be a voice input or automatic character recognition, for example.

During the comparison step 404, the response entered is compared to a response contained in a database and/or the message. The response contained in a database can be a recording of the code generated initially. The response contained in the message can depend on the decoding of the message, and match a value of the message, for example of a signature or a header of the message. The comparison 404 can be performed by a microprocessor 504 of the terminal 506 executing a computer program.

During the broadcasting step 405, the alert can be visual, on the screen 502 of the terminal 506, or audible, on an electroacoustic transponder 505 of the terminal.

In some embodiments, the display 402, entry 403 and comparison 404 steps are iterated at least twice, each iteration concerning a different cell.

In some embodiments, when at least one cell of the 2D barcode is a fragile anti-copy mark, the reader determines whether the mark is an original or a copy, and the terminal 506 can display this information.

FIG. 5 shows a particular embodiment of a device 50 for authenticating an object, said device being the subject of the present invention, which comprises:
the predetermined reader 501 of a 2D barcode secured by a method 40, representative of at least one access to a remote resource;
a terminal 506 accessing the remote resource, the terminal comprising:
a means 502 for displaying a question relating to the image represented in at least one cell;
a means 503 for entering a response to the question displayed;
a means 504 for comparing the response entered with a response contained in a database or the message; and
if the responses do not match, a means, 502 or 505, for broadcasting an alert message to the user.

Preferably, the embodiments of the device 50 are configured to utilize the steps of the method 40 and their embodiments as described above, and the method 40 and its different embodiments can be utilized by the embodiments of the device 50.

1. Method for securely marking an object, said method being characterized in that it comprises:
a step of determining a maximum size for each cell of a 2D barcode defined according to at least two predetermined colors, the maximum size of each cell being defined by an area containing a number of dots;
a step of estimating a minimum number of dots of one color, among the two colors defining said 2D barcode, referred to as the “main color”, in a cell of the 2D barcode such that the cell is detected as being said color by a predetermined reader;
a step of encoding a message in at least one portion of cells of the 2D barcode by defining the main color, this message representing at least one instance of access to a remote resource;
for at least one cell of the 2D barcode, a step of incorporating an image in said cell, the number of dots in the color image defining the cell being greater than or equal to the estimated minimum number; and
a step of marking the object with the secure 2D barcode.

2. Method according to claim 1, wherein, the remote resource generates at least one question about the image represented by at least one cell of the barcode marked.

3. Method according to claim 1, wherein at least one cell of the 2D barcode is a fragile anti-copy mark.

4. Method according to claim 1, wherein during the encoding step (103), the message is encoded with redundancies and/or an error correction code.

5. Method according to claim 1, wherein the image is representative of an alphanumeric character.

6. Method according to claim 1, wherein the image is selected randomly or pseudo-randomly from a library of images.

7. Method according to claim 1, which also comprises a step (106) of orienting the image in the area defining the cell.

8. Method according to claim 1, wherein the image is represented by a color with a luminance greater than the luminance of the main color.

9. Device for securely marking an object, said device being characterized in that it comprises:
a means for determining a maximum size for each cell of a 2D barcode defined according to at least two predetermined colors, the maximum size of each cell being defined by an area containing a number of dots;
a means for estimating a minimum number of dots of one color, among the two colors defining said 2D barcode, referred to as the “main color”, in a cell of the 2D barcode such that the cell is detected as being said color by a predetermined reader;
a means for encoding a message in at least one portion of cells of the 2D barcode by defining the main color, this message representing at least one instance of access to a remote resource;
a means for incorporating, for at least one cell of the 2D barcode, an image in said cell, the number of dots in the color image defining the cell being greater than or equal to the estimated minimum number; and
a means for marking the object with the secure 2D barcode.

10. Method for authenticating an object, said method being characterized in that it comprises:
a step of reading, by means of the predetermined reader, a secure 2D barcode, representative of at least one access to a remote resource, obtained by a method according to claim 1;
by means of a terminal accessing the remote resource:
a step of displaying a question relating to the image incorporated into at least one cell;
a step of entering a response to the question displayed;
a step of comparing the response entered with a response contained in a database and/or the message; and
if the responses do not match, a step of broadcasting an alert message to the user.

11. Device for authenticating an object, said device being characterized in that it comprises:
the predetermined reader of a secure 2D barcode, representative of at least one access to a remote resource, obtained by a method according to claim 1;
a terminal accessing the remote resource, the terminal comprising:
a means for displaying a question relating to the image incorporated into at least one cell;
a means for entering a response to the question displayed;
a means for comparing the response entered with a response contained in a database and/or the message; and
a means for broadcasting an alert message to the user if the responses do not match.
